(19) United States
(12) Patent Application Publication
(10) Pub. No.: US 2019/0217949 A1
(43) Pub. Date: Jul. 18, 2019

(54) ROTORCRAFT CONTROL SYSTEMS

(71) Applicant: SIKORSKY AIRCRAFT CORPORATION, Stratford, CT (US)

(72) Inventors: Daniel Bazzani, Jupiter, FL (US); Nikolas A. Macko, Stuart, FL (US); Peter J. Waltner, Royal Palm Beach, FL (US); Kenneth S. Wittmer, Sandy Hook, CT (US)

(21) Appl. No.: 15/874,709

(22) Filed: Jan. 18, 2018

(51) Int. Cl. B64C 27/57; B64C 27/82; G05D 1/10

(52) U.S. Cl. CPC B64C 27/57; B64C 2027/8236; G05D 1/102; B64C 27/82

(57) ABSTRACT

A rotorcraft control system can include a controller configured to receive an input from a pilot or autopilot for controlling at least one of a rotor and/or a performance profile of the rotorcraft and to control a propulsor as a function of the input for controlling the propulsor relative to the rotor and/or for achieving the input performance profile, wherein the controller is configured to fly the aircraft in accordance with the performance profile or to conform manual control inputs to the performance profile.

### BACKGROUND

### 1. Field

The present disclosure relates to rotorcraft control systems.

### 2. Description of Related Art

In order to realize the best performance while providing a reasonable pilot workload, there is a need to control and optimize the acceleration/deceleration profiles for a helicopter with an auxiliary/integrated propulsor. The complicated control system inputs of cyclic control, yaw control, and main rotor collective control required in a conventional helicopters are already taxing to a human pilot. Adding a propulsor increases the degrees of freedom of the system, thus adding to the pilot workload for a hand-flown optimal acceleration profile.

For civil operations, the maximum gross weight capability in transport vertical operations (e.g., Category A, which is an FAA airworthiness standard that requires zero exposure to an engine failure by assuring flying or landing operability on a single engine for multiengine aircraft in accordance with 14 C.F.R. 29) requires first and second segment single engine climb capability. Additional dynamic constraints such as pilot visibility based on minimum helipad size and Takeoff Decision Point (TDP) height, pilot workload, ground clearance from drop down, deck edge clearance for elevated operations, landing gear loads, and flapping/structural limits will reduce the maximum weight below the theoretical first and second segment single engine climb capability weights. A helicopter with an auxiliary propulsor is normally designed to provide higher cruise speeds and improved range capability to a conventional helicopter but can be often be limited in useful load due to a higher empty weight fraction. It is therefore beneficial to investigate improvements to the takeoff profile in order to maximize the weight and useful load of the helicopter, e.g., for Category A vertical operations.

Such conventional methods and systems have generally been considered satisfactory for their intended purpose. However, there is still a need in the art for improved rotorcraft control systems for aircraft with auxiliary propulsion systems. The present disclosure provides a solution for this need.

### SUMMARY

In accordance with at least one aspect of this disclosure, a rotorcraft controller system can include a controller configured to receive an input from a pilot or autopilot for controlling at least one of a rotor and/or a performance profile of the rotorcraft and to control a propulsor as a function of the input for controlling the propulsor relative to the rotor and/or for achieving the input performance profile, wherein the controller is configured to fly the aircraft in accordance with the performance profile or to conform manual control inputs to the performance profile.

The controller can be configured to receive a performance profile selection and an execution command to automatically control the aircraft as a function of the performance profile selection. The input performance profile can include a maximum acceleration profile. The input performance profile can include a hover, wherein at least relative attitude and relative position are selected and held constant.

The controller can be configured to achieve the hover by controlling the rotor to pitch the rotorcraft forward and controlling the propulsor to provide reverse thrust to hold the aircraft in position and at a preselected attitude.

The input can be a manual control input from at least one of a collective, a cyclic, a velocity, an attitude rate, an attitude, an acceleration, a thrust, and/or a throttle control. The input can include the performance profile and at least one of a preselected speed, a preselected vertical speed, a preselected pitch, and/or a preselected altitude.

The input can include an execution command to achieve the at least one of preselected speed, vertical speed, pitch, and/or altitude via the input performance profile using autopilot. The controller can be configured to output a performance profile deviation or disengage signal to an indicator in the event of unplanned acceleration and/or other unplanned motion outside of the performance profile due to one or more smart autopilot routines and/or due to manual unplanned control of the aircraft.

In accordance with at least one aspect of this disclosure, a method for controlling a rotorcraft having at least a rotor and a propulsor, the method comprising receiving an input from a pilot or autopilot for controlling at least one of a rotor and/or a performance profile of the rotorcraft, and controlling a propulsor as a function of the input for controlling the propulsor relative to the rotor and/or for achieving the input performance profile. Controlling the propulsor for achieving the input performance profile can include flying the aircraft in accordance with the performance profile or conforming manual control inputs to the performance profile.

Receiving an input from a pilot can include receiving a performance profile selection and an execution command to automatically control the aircraft as a function of the performance profile selection. The input performance profile can include a maximum acceleration profile. The input performance profile can include a hover, wherein at least attitude and position are selected and held constant. The hover can be achieved by controlling the rotor to pitch the rotorcraft forward and controlling the propulsor to provide reverse thrust to hold the aircraft in position and at a preselected attitude.

Receiving an input from a pilot can include receiving a manual control input from at least one of a collective, a cyclic, a throttle, and/or a propulsor thrust control. Receiving an input includes receiving the performance profile and at least one of a preselected speed, a preselected pitch, and/or a preselected altitude.

The receiving input can include receiving an execution command to achieve the at least one of preselected speed, pitch, and/or altitude via the input performance profile using autopilot. The method can include outputting a performance profile deviation or disengage signal to an indicator in the event of unplanned acceleration and/or other unplanned motion outside of the performance profile due to one or more smart autopilot routines and/or due to manual unplanned control of the aircraft.

In accordance with at least one aspect of this disclosure, a rotorcraft controller system can include a non-transitory computer readable medium including computer executable instructions for performing any suitable embodiment of a method and/or any suitable portions thereof as described herein.

In accordance with at least one aspect of this disclosure, rotorcraft can include a controller system configured to receive an input from a pilot or autopilot for controlling at least one of a rotor and/or a performance profile of the rotorcraft and to control a propulsor as a function of the input for controlling the propulsor relative to the rotor and/or for achieving the input performance profile. The rotorcraft can have a soft limit on a manual control input (e.g., a cyclic) to override the profile such that manual control beyond a certain limit gives full normal power.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective schematic view of a rotorcraft in accordance with this disclosure, shown having a rotorcraft control system.

FIG. 2 shows a functional diagram of an embodiment of a system in accordance with this disclosure;

FIG. 3 shows an embodiment of a chart having qualitative definitions of certain selectable performance profiles in accordance with FIG. 2.

### DETAILED DESCRIPTION

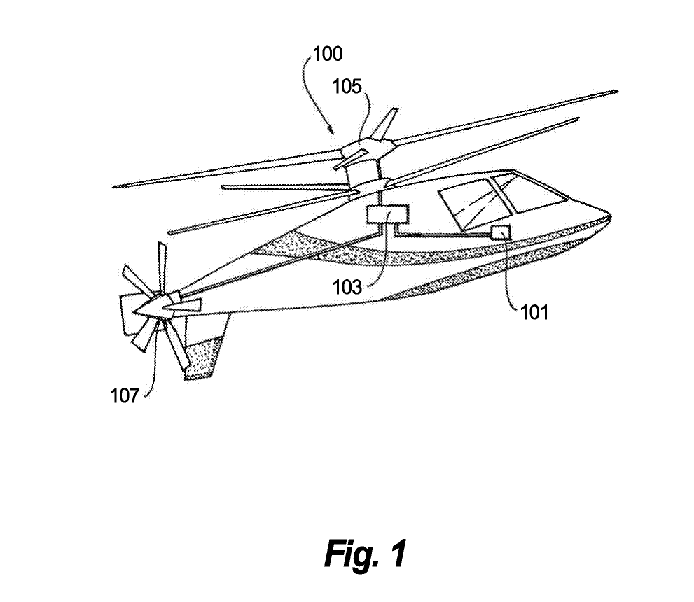

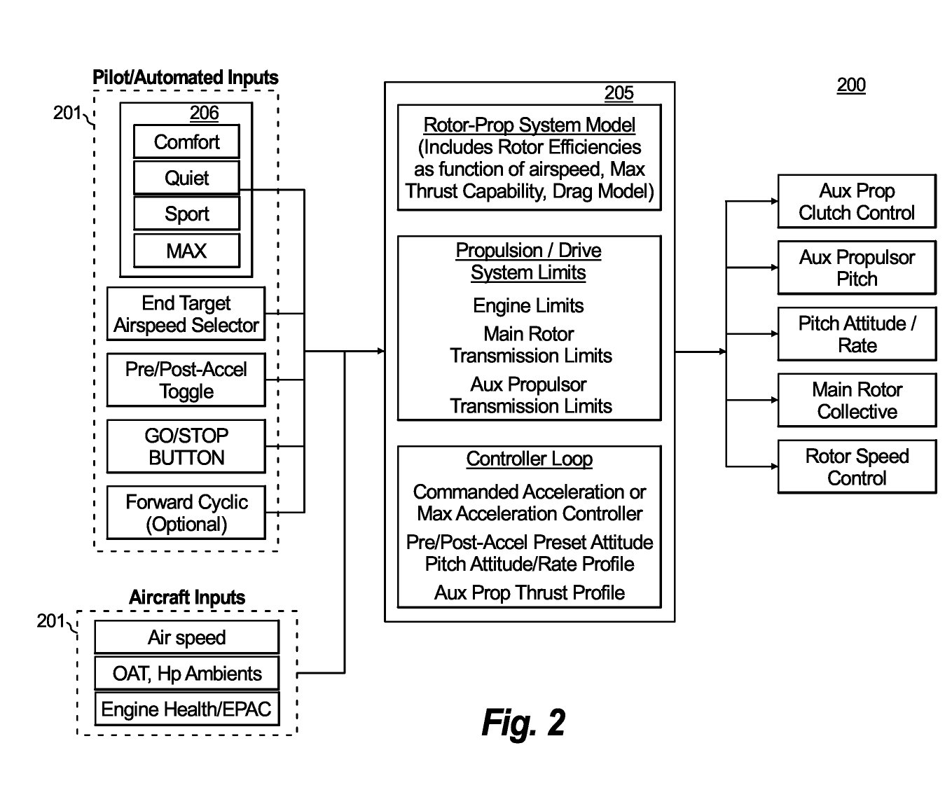

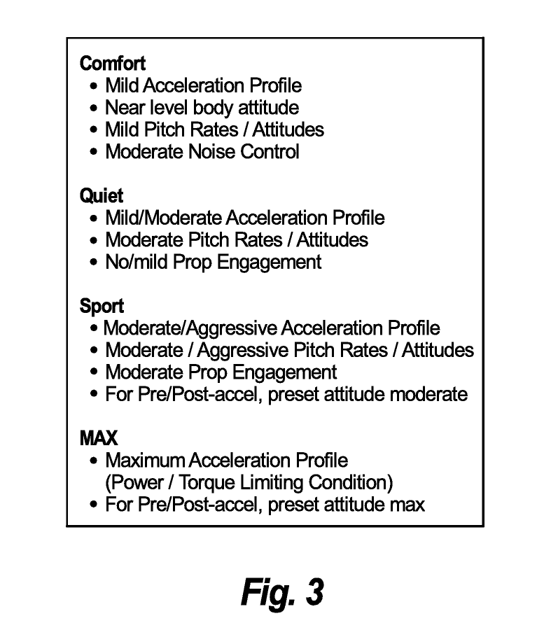

Reference will now be made to the drawings wherein like reference numerals identify similar structural features or aspects of the subject disclosure. For purposes of explanation and illustration, and not limitation, an illustrative view of an embodiment of a rotorcraft in accordance with the disclosure is shown in FIG. 1 and is designated generally by reference character 100. Other embodiments and/or aspects of this disclosure are shown in FIGS. 2 and 3. The systems and methods described herein can be used to improve performance and controllability of rotorcraft having one or more propulsors, for example, or for any other suitable use.

In accordance with at least one aspect of this disclosure, with reference to FIG. 1, embodiments of a method for controlling a rotorcraft 100 having at least a rotor 105 and a propulsor 107 are described herein. The method can include receiving an input (e.g., at a controller 103) from a pilot or autopilot (e.g., via control input 101) for controlling at least one of a rotor 105 (e.g., collective pitch and/or cyclic angle) and/or a performance profile of the rotorcraft 100. It should be understood that the controller 103 and/or the control input 101 can include any suitable hardware and/or software, and can be separate unit or combined together in a single unit. Moreover, each can also include a single unit and/or a plurality of units as appreciated by those having ordinary skill in the art.

The method can include controlling a propulsor 107, e.g., using the controller 103, as a function of the input in order to control the propulsor 107 relative to the rotor 105 and/or for achieving the input performance profile. Receiving an input from a pilot can include receiving a performance profile selection and an execution command to automatically control the aircraft 100 as a function of the performance profile selection. In such embodiments, the aircraft 100 can autonomously control itself and the propulsor 107 to achieve the performance profile selection. Any suitable manual and/or automatic control of any and/or all parts of the aircraft are contemplated herein. Also, it is contemplated that at least some manual inputs may be integrated with automatic control and/or capable of interrupting and/or overriding automatic control as appreciated by those having ordinary skill in the art. Controlling the propulsor for achieving the input performance profile can include flying the aircraft in accordance with the performance profile or conforming manual control inputs to the performance profile.

Inputs to controller 103 can be manual or automated. In certain embodiments, the inputs can be made in an Automate Mode and/or a Manual Mode. In an embodiment of a Automated Mode, preset conditions can be utilized. For example, preset final speed capture target, altitude, climb rate profile, preset acceleration mode (e.g., nose down hover). In an embodiment of a Manual Mode, an automatic flight control system (AFCS) cyclic input can control acceleration, for example.

The control input 101 can include a profile selector that can be a physical switch and/or a software item (e.g., displayed on an MFD for example). The profile selector can be used to set an acceleration profile (e.g., Maximum acceleration, Quiet, Comfort, etc.), which can be pre-defined or customized.

The controller 103 can include a profile calculation module. The profile calculation module can take in the profile selector setting, as well as one or more of aircraft state parameters, configuration, weight, ambient conditions, engine limits, or transmission limits, or any other suitable parameter, and feed them into an energy model of the aircraft with the main rotor and propeller efficiencies. The calculation module can output settings to optimize one or more flight systems (e.g., the trim condition and profile) to provide a solution for achieving the desired profile selection (e.g., without exceeding limits, or minimizing limit exceedance). Output settings can include one or more of auxiliary propulsor thrust control settings, main rotor collective settings, pitch attitude as a function of time settings, position settings, and/or speed setting, and/or any other suitable settings. For example, in order to optimize the acceleration/deceleration profiles that will be commanded, a profile calculator can be used that includes an energy model of the aircraft including the main rotor and prop efficiencies.

Efficiencies are important because it allows the calculator to find the best acceleration with combination of rotor thrust, prop thrust and pitch attitude. For example if the rotor produces higher static thrust forward component (better rotor efficiency) in hover with a nose down pitch attitude as compared to using the prop in level body, then the calculator can find that using the rotor and pitching the nose down initially provides a greater acceleration. If the efficiencies are better at higher speed using the prop then the acceleration profile will transition to the prop therefore providing the maximum performance acceleration. It may also be a combination of both. Inputs such as desired acceleration rate, power available information, main and prop torque limits, aircraft weight and ambient conditions can be calculated or input into the calculation module by the operator.

The settings can be proportioned to pilot stick input if manual mode is being flown. In certain embodiments, the profile calculation module can actively calculate and/or recalculate settings, e.g., in certain conditions during flight (e.g., in engine failure mode).

In certain embodiments, the controller 103 can also include a flight control module configured to receive the settings from the profile calculation module and output the settings to the one or more flight control systems of the aircraft (e.g., automatic flight control system (AFCS), auxiliary propulsor thrust control, main rotor collective, pitch attitude as a function of time, position, or speed) which drives the servos to control propulsor, main rotor blade pitch, and/or control surfaces.

The input performance profile can include a maximum acceleration profile (e.g., to achieve a desired speed most efficiently and/or quickly). The input performance profile can include any suitable profile (e.g., a passenger carrying profile having a less abrupt acceleration scheme, a minimum acoustics profile for reducing aircraft noise). The performance profile can be any suitable profile that controls how the aircraft flies (e.g., how the aircraft accelerates and to what speed, how the aircraft maneuvers and the abruptness and/or degree of maneuvers such as roll, pitch, and yaw).

For example, in certain embodiments, the input performance profile (e.g., the maximum acceleration profile in certain embodiments) can include a hover. For example, an optimal profile hover can be utilized in a system health failure (e.g., engine failure/single engine case, propeller gear failure), e.g., for Category A operation (e.g., such as medical evacuation or other emergency flight). A condition of the engine or other system can be sensed and the sensed condition can change what qualifies as optimal operation. For example, one or more failures of an engine and/or system can add various constraints to the profile calculation module to adjust operation of the profile calculation module to account for the one or more failures.

In a hover, at least relative attitude and relative position (e.g., relative to a fixed object or terrain, or a moving object such as a ship) can be selected and held constant. The hover can be achieved by controlling the rotor 105 to pitch the rotorcraft 100 forward (e.g., using cyclic control that is controlled by the autopilot or autonomously for example) and controlling the propulsor 107 to provide reverse thrust to hold the aircraft 100 in position and at a preselected attitude. Any other suitable manual or automatic control to hover is contemplated herein as appreciated by those having ordinary skill in the art in view of this disclosure.

In certain embodiments, receiving an input from a pilot can include receiving a manual control input from at least one of a collective, a cyclic, a throttle, and/or propulsor thrust control. For example, the pilot can fly the rotorcraft 100 manually (e.g., as a regular helicopter via the standard three axis rotorcraft controls), and the propulsor 107 can be controlled as a function of the manual inputs. For example, the pilot can push forward on the cyclic and the propulsor speed, power, and/or pitch can change to cause forward motion (along with any other suitable movement of the rotor 105). In this manner, and depending upon operational mode or rotorcraft 100, the pilot control inputs may optionally or additionally be a thrust, a velocity, an acceleration, an attitude, and/or an attitude rate among other control possibilities (e.g., high level control) suitable for control of rotorcraft 100.

In certain embodiments, receiving an input includes receiving the performance profile and at least one of a preselected speed, a preselected vertical speed, a preselected pitch, and/or a preselected altitude, and/or ground/terrain clearance. For example, the pilot can manually input any these values into a multifunction display (MFD) or any other suitable interface before takeoff.

Receiving an input can include receiving an execution command to achieve the at least one of preselected speed, vertical speed, pitch, and/or altitude via the input performance profile using autopilot. For example, the pilot can select a “go” button on an MFD interface after inputting a desired performance profile and/or other suitable flight characteristic.

The method can include outputting a performance profile deviation or disengage signal to an indicator in the event of unplanned acceleration and/or other unplanned motion outside of the performance profile due to one or more smart autopilot routines and/or due to manual unplanned control of the aircraft. This can serve to notify the pilot that the performance profile is no longer being achieved due to one or more reasons (e.g., emergency procedure, evasive maneuvers).

In accordance with at least one aspect of this disclosure, an rotorcraft controller 103 can include a non-transitory computer readable medium including computer executable instructions for performing any suitable embodiment of a method and/or any suitable portions thereof as described herein. The controller 103 can include any suitable computer hardware and/or software.

The input 101 can include any suitable hardware and/or software for controlling one or more systems of the aircraft, for example. In certain embodiments, the input 101 can include a traditional rotor control (e.g., a cyclic, a collective, any other suitable manual control (e.g., high level control) a throttle) and/or one or more other aircraft systems inputs (e.g., an MFD, a touch screen interface, or a portable device). In certain embodiments, the controller 103 and the input 101 and/or any suitable portion thereof can be a single unit or any suitable number of units. Any suitable combination and/or partitions thereof are contemplated herein.

In accordance with at least one aspect of this disclosure, the controller 103 can be configured to receive an input from a pilot or autopilot for controlling at least one of a rotor 105 and/or a performance profile of the rotorcraft 100 and to control a propulsor 107 as a function of the input for controlling the propulsor 107 relative to the rotor and/or for achieving the input performance profile.

Embodiments can incorporate partially and/or fully automated control of one or more auxiliary propulsors 107, pitch attitude, and/or main rotor collective to control and optimize the aircraft's acceleration profile. A rotorcraft 100 with an auxiliary propulsor 107 has an additional degree of freedom along the thrust line that when coupled with an advanced fly by wire flight control system can provide the pilot with the ability to set the pitch attitude while allowing the propulsor to control airspeed/groundspeed. For takeoffs, this feature can provide the pilot with the ability to maintain the aircraft above the helipad, e.g., during the vertical climb while setting the aircraft to a nose down pitch attitude and reverse thrust on the auxiliary propulsor.

The controller can preset the pitch attitude of the aircraft while in hover or in a vertical climb to provide an optimal attitude for best acceleration performance based on operational mode. The auxiliary propulsor can be utilized to hold longitudinal position, for example. The pilot or operator can cue in the acceleration when desired at which point the auxiliary propulsor, collective pitch, and pitch attitude can be scheduled to provide the desired acceleration profile with minimal pilot workload. In certain embodiments, the aircraft control system can also account for torque limiting conditions between the main rotor and the auxiliary propulsor drive system and/or any system failures (e.g., engine failure) to optimize the acceleration profile based on those performance limiting conditions.

In certain embodiments, a similar optimization can also be used for a deceleration profile, for example. A level body or descending deceleration is normally limited on a conventional helicopter by the pitch attitude. Embodiments utilizing the auxiliary propulsor can provide a way to increase the deceleration rate and minimize vertical speed for a higher pitch attitude, for example. While decelerating, the auxiliary propulsor thrust may be controlled to avoid adverse autorotative and windmill states which can lead to drive system overspeed conditions. Controlling the acceleration/deceleration using embodiments can also be utilized to reduce takeoff and landing distances for both airfield and vertical operations than would otherwise be realized without a maximum profile.

The acceleration profile can also be selectable (e.g., via electronic flight display (EFD), MFD display, or any other suitable switch) depending on, e.g., passenger comfort, operational (e.g., acoustics), and/or performance goals. In order to optimize the performance profiles that will be commanded, a profile calculator can be included as described above that includes an energy model of the aircraft with the main rotor and prop efficiencies. Inputs such as desired acceleration rate, power available information, main and prop torque limits, aircraft weight and ambient conditions can be calculated or input by the operator. For planned accelerations the recommended profile may consist of a pre-acceleration attitude hold, in order to set aircraft in the best attitude for greatest acceleration.

The propulsor (e.g., in reverse thrust) can be used to hold the aircraft position for the desired acceleration attitude. When ready, the operator can then initiate the automated acceleration profile which will quickly change the propulsor thrust from negative to either zero or positive thrust depending on the maximum profile. This initiation of acceleration may also be scheduled to occur at a certain point through a recommended profile, such as at a takeoff decision point (TDP) which may be defined by meeting one or more conditions within the profile. Alternatively, in certain embodiments, for unplanned accelerations, a pre-acceleration attitude hold function may not be required. A different acceleration profile can be actively calculated and reserved in queue for when it is needed (e.g. an engine failure or change in operational requirement). The operator can immediately access this feature (manually or automatically) to quickly accelerate with minimal delay (e.g., maximum acceleration). A similar set of calculated profiles and features can be adapted for a deceleration function of the controller, for example.

Embodiments and/or any suitable portions thereof can be integrated with an advanced flight control system. In certain embodiments, multiple modes can exist. In a high augmentation mode, the propulsor inputs can be controlled automatically by the flight system, whereas in a mode with less augmentation, the propulsor inputs can be controlled by the pilot using any suitable manual input and/or as a function of other rotor control inputs. In either mode, various levels of control of rotor and/or propulsor augmentation may be utilized to enhance the acceleration and/or deceleration of the rotorcraft 100.

The rotorcraft can have a soft limit on a manual control input (e.g., a cyclic) to override the profile such that manual control beyond a certain limit gives full normal power. For example, a pilot can push a cyclic beyond a certain degree and cause the performance profile conformance to disengage allowing full manual control of the aircraft (e.g., for evasive maneuvers). Referring to FIG. 2, a system 200 is shown having inputs 201 and controller 203. Inputs include certain profile selections 206. FIG. 3 includes descriptions of these performance profiles.

In accordance with at least one aspect of this disclosure, a rotorcraft controller system can include a controller (e.g., controller 103) configured to receive an input from a pilot or autopilot for controlling at least one of a rotor and/or a performance profile of the rotorcraft and to control a propulsor as a function of the input for controlling the propulsor relative to the rotor and/or for achieving the input performance profile, wherein the controller is configured to fly the aircraft in accordance with the performance profile or to conform manual control inputs to the performance profile.

The controller can be configured to receive a performance profile selection and an execution command to automatically control the aircraft as a function of the performance profile selection. The input performance profile can include a maximum acceleration profile. The input performance profile can include a hover, wherein at least relative attitude and relative position are selected and held constant.

The controller can be configured to achieve the hover by controlling the rotor to pitch the rotorcraft forward and controlling the propulsor to provide reverse thrust to hold the aircraft in position and at a preselected attitude.

The input can be a manual control input from at least one of a collective, a cyclic, a velocity, an attitude rate, an attitude, an acceleration, a thrust, and/or a throttle control. The input can include the performance profile and at least one of a preselected speed, a preselected vertical speed, a preselected pitch, and/or a preselected altitude.

The input can include an execution command to achieve the at least one of preselected speed, vertical speed, pitch, and/or altitude via the input performance profile using autopilot. The controller can be configured to output a performance profile deviation or disengage signal to an indicator in the event of unplanned acceleration and/or other unplanned motion outside of the performance profile due to one or more smart autopilot routines and/or due to manual unplanned control of the aircraft.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Referring to FIG. 2, aspects of the present invention may be shown and described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein. Any suitable user interface, input system, and/or display for any embodiment and/or portion thereof is contemplated herein.

Embodiments can optimize the acceleration profile at takeoff decision point (TDP) which results in lower dropdown and reduced exposure to deck edge which will provide an increase in useful load. For time critical missions such as Category A Search and Rescue (SAR) (Human External Cargo), embodiments can minimize the time to accelerate out of a hover in the event of an engine failure which increases the time allowed to accomplish the rescue.

For military operations, embodiments of the acceleration controller can provide the operator greater agility, survivability, and safety when transitioning from weapon employment in hover to cruise condition if avoiding ground fire or other adverse combat conditions. The pilot can focus on the mission and the threats rather than scheduling in the control inputs for a maximum performance acceleration.

By way of example, aspects of the invention can be used in coaxial helicopters, on tail rotors, compound helicopters (e.g., both single and dual main rotor designs), or wings or propeller blades on fixed or tilt wing aircraft, or any other suitable aircraft or component thereof.

The terms “a” or “an” as used herein and in the claims below are is defined as “one or more” or “at least one.”

The methods and systems of the present disclosure, as described above and shown in the drawings, provide for rotorcraft control systems with superior properties. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A rotorcraft controller system comprising:
a controller configured to receive an input from a pilot or autopilot for controlling at least one of a rotor and/or a performance profile of the rotorcraft and to control a propulsor as a function of the input for controlling the propulsor relative to the rotor and/or for achieving the input performance profile,
wherein the controller is configured to fly the aircraft in accordance with the performance profile or to conform manual control inputs to the performance profile.

2. The system of claim 1, wherein the controller is configured to receive a performance profile selection and an execution command to automatically control the aircraft as a function of the performance profile selection.

3. The system of claim 1, wherein the input performance profile includes a maximum acceleration profile.

4. The system of claim 1, wherein the input performance profile includes a hover, wherein at least relative attitude and relative position are selected and held constant.

5. The system of claim 4, wherein the controller is configured to achieve the hover by controlling the rotor to pitch the rotorcraft forward and controlling the propulsor to provide reverse thrust to hold the aircraft in position and at a preselected attitude.

6. The system of claim 1, wherein the input is a manual control input from at least one of a collective, a cyclic, a velocity, an attitude rate, an attitude, an acceleration, a thrust, and/or a throttle control.

7. The system of claim 1, the input includes the performance profile and at least one of a preselected speed, a preselected vertical speed, a preselected pitch, and/or a preselected altitude.

8. The system of claim 7, wherein the input includes an execution command to achieve the at least one of preselected speed, vertical speed, pitch, and/or altitude via the input performance profile using autopilot.

9. The system of claim 8, wherein the controller is configured to output a performance profile deviation or disengage signal to an indicator in the event of unplanned acceleration and/or other unplanned motion outside of the performance profile due to one or more smart autopilot routines and/or due to manual unplanned control of the aircraft.

10. A method for controlling a rotorcraft having at least a rotor and a propulsor, the method comprising:
receiving an input from a pilot or autopilot for controlling at least one of a rotor and/or a performance profile of the rotorcraft; and
controlling a propulsor as a function of the input for controlling the propulsor relative to the rotor and/or for achieving the input performance profile.

11. The method of claim 10, wherein receiving an input from a pilot includes receiving a performance profile selection and an execution command to automatically control the aircraft as a function of the performance profile selection.

12. The method of claim 10, wherein the input performance profile includes a maximum acceleration profile.

13. The method of claim 10, wherein the input performance profile includes a hover, wherein at least relative attitude and relative position are selected and held constant.

14. The method of claim 13, wherein the hover is achieved by controlling the rotor to pitch the rotorcraft forward and controlling the propulsor to provide reverse thrust to hold the aircraft in position and at a preselected attitude.

15. The method of claim 10, wherein receiving an input from a pilot includes receiving a manual control input from at least one of a collective, a cyclic, a thrust, a velocity, an attitude rate, an attitude, an acceleration, a throttle, and/or a propulsor thrust control.

16. The method of claim 10, wherein receiving an input includes receiving the performance profile and at least one of a preselected speed, a preselected vertical speed, a preselected pitch, and/or a preselected altitude.

17. The method of claim 16, wherein the receiving an input includes receiving an execution command to achieve the at least one of preselected speed, vertical speed, pitch, and/or altitude via the input performance profile using autopilot.

18. The method of claim 17, further including outputting a performance profile deviation or disengage signal to an indicator in the event of unplanned acceleration and/or other unplanned motion outside of the performance profile due to one or more smart autopilot routines and/or due to manual unplanned control of the aircraft.

19. A rotorcraft comprising:
a controller system configured to receive an input from a pilot or autopilot for controlling at least one of a rotor and/or a performance profile of the rotorcraft, and to control a propulsor as a function of the input for controlling the propulsor relative to the rotor and/or for achieving the input performance profile.

20. The rotorcraft of claim 19, wherein the rotorcraft has a soft limit on the cyclic to override the profile such that manual control beyond a certain limit gives full normal power.
